(19) United States
(12) Patent Application Publication
(10) Pub. No.: US 2010/0011098 A1
(43) Pub. Date: Jan. 14, 2010

(54) Systems and methods for managing networks

(75) Inventors: Roger Sanborn, Maple Ridge (CA); Jeremy Sheldon, Maple Ridge (CA)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: 90 Degree Software Inc., Vancouver British Columbia (CA)

(21) Appl. No.: 12/309,203

(22) PCT Filed: Jul. 9, 2007
(86) PCT No.: PCT/CA2007/001206

§ 371 Date: Jul. 15, 2009

Related U.S. Application Data
(60) Provisional application No. 60/806,788, filed on Jul. 9, 2006.

(51) Int. Cl. G06F 15/173

(52) U.S. Cl. 709/223; 709/224

(57) ABSTRACT

A system for managing an adaptive network having a plurality of nodes, each node comprising a processor coupled to a memory containing computer readable instructions which, when executed by the processor, cause the node to fulfil one or more roles for operating the adaptive network. preferably, at least one of the nodes has an active administrative role. this administrative node is configured to determine network conditions and selectively activate roles on the plurality of nodes based on the network conditions.

### RELATED APPLICATIONS

This application claims benefit to provisional patent application No. 60/806,788, filed Jul. 9, 2006, which is hereby incorporated by reference.

### TECHNICAL FIELD

The invention relates to managing computer networks, and more particularly computer networks having a plurality of nodes.

### BACKGROUND

Some available types of network configuration include pure peer-to-peer, client/server, and hybrid peer-to-peer. In pure peer-to-peer network configurations, each computing node have has equal status. Such nodes may be referred to as “peers”. All such peers may be considered the same in terms of privileges and roles. In client/server network configurations, servers may be considered superior to clients with regard to function and privileges, and clients may defer to servers for operations. In hybrid peer-to-peer network configurations, peers may be considered equal with respect to some privileges and roles and unequal with respect to other privileges and roles.

The foregoing examples of the related art and limitations related thereto are intended to be illustrative and not exclusive. Other limitations of the related art will become apparent to those of skill in the art upon a reading of the specification and a study of the drawings.

There exists a need for networks configured to adapt in response to changing network conditions.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a system for managing a network, the system having a plurality of nodes connected to an adaptive network, each of the plurality of nodes having a processor coupled to a memory containing computer readable instructions which, when executed by the processor, cause the node to fulfil at least one role for operating the adaptive network, and instructions which, when executed by the processor, cause the processor to monitor for a request from an administrative node to activate said at least one role; and wherein the administrative node has an active administrative role, and the administrative node is configured to determine network conditions and selectively send requests to activate roles on the plurality of nodes based on the network conditions.

The administrative node may be configured to determine network conditions by querying other nodes connected to the adaptive network regarding network conditions observed by the other nodes. The administrative node may be configured to determine network conditions by monitoring traffic on links of the adaptive network which are connected to the administrative node. The administrative node may be configured to compare the determined network conditions to one or more predetermined target conditions to identify any unfulfilled desired roles; and if an unfulfilled desired role is identified, send a role activation request to one of the plurality of nodes connected to the network which is configured to fulfil the desired role. The administrative node may be configured to: compare the determined network conditions to one or more predetermined target conditions to identify any active undesired roles; and if an active undesired role is identified, send a role deactivation request to one of the plurality of nodes connected to the network whereon the undesired role is active. The administrative node may be configured to: compare the determined network conditions to one or more predetermined target conditions to identify any active undesired roles; and if an active undesired role is identified, send a role deactivation request to one of the plurality of nodes connected to the network whereon the undesired role is active. The administrative node may be configured to activate a metadata index server role on at least one of the plurality of nodes connected to the adaptive network if a load on the adaptive network exceeds a predetermined threshold load. The administrative node may be configured to activate a file server role on at least one of the plurality of nodes connected to the adaptive network if a number of nodes connected to the adaptive network exceed a first predetermined number. The administrative node may be configured to deactivate all file server roles on the plurality of nodes connected to the adaptive network if the number of nodes connected to the adaptive network is lower than a second predetermined number which is lower than the first predetermined number. The administrative node may be configured to activate a metadata index server role and a file server role on one or more of the plurality of nodes connected to the adaptive network if a number of nodes connected to the adaptive network exceed 500.

Another aspect of the invention provides for a system for managing a network, the system having a plurality of nodes connected to an adaptive network, each of the plurality of nodes having at least one role-performing unit configured to fulfil at least one role for operating the adaptive network, and a monitoring unit configured to monitor for a request from an administrative node to selectively activate or deactivate the at least one role-performing unit, wherein the administrative node has an active administrative role, and the administrative node is configured to determine network conditions and selectively send requests to activate or deactivate role-performing units of the plurality of nodes based on the network conditions.

Another aspect of the invention provides for a system for managing a network, the system having a plurality of nodes connected to an adaptive network, each of the plurality of nodes having means for fulfilling at least one role for operating the adaptive network; and means for monitoring for a request from an administrative node to selectively activate or deactivate the means for fulfilling at least one role, wherein the administrative node has an active administrative role, the administrative node is configured to determine network conditions and selectively send requests to activate or deactivate role-performing units of the plurality of nodes based on the network conditions.

Another aspect of the invention provides a method for managing a computing network. The method includes providing a plurality of nodes connected to an adaptive network, each node comprising a processor coupled to a memory containing computer readable instructions which, when executed by the processor, cause the node to fulfil one or more roles for operating the adaptive network; querying the plurality of nodes to determine conditions of the adaptive network; determining one or more desired roles for the adaptive network based on the determined conditions; determining if any of the one or more desired roles are unfulfilled in the adaptive network; and, for each unfulfilled desired role, sending a role activation request to one of the plurality of nodes configured to fulfil that desired role.

The method may include determining one or more undesired roles for the adaptive network based on the determined conditions; determining if any of the one or more undesired roles are active in the adaptive network; and, for each active undesired role, sending a role deactivation request to one of the plurality of nodes whereon the undesired role is active. The method may include determining one or more desired roles comprises comparing the determined conditions to one or more predetermined target conditions. The method may include determining one or more desired roles comprises designating a metadata index server role as a desired role if a load on the adaptive network exceeds a predetermined threshold load. The method may also include determining one or more desired roles comprises designating a file server role as a desired role if a number of nodes connected to the adaptive network exceeds a predetermined number.

Another aspect of the invention provides a method for operating a node, the method including: configuring the node to selectively fulfil one or more roles; connecting the node to an adaptive network; sending node information out over the adaptive network, the node information having information specifying the one or more roles which the node is configured to fulfil; receiving network information from the adaptive network; monitoring network traffic for a role activation request relating to the one or more roles which the node is configured to fulfil; and, in response to a role activation request relating to the one or more roles which the node is configured to fulfil: activating the requested role; updating the node information; and, sending a confirmation that the requested role has been activated.

Another aspect of the invention provides for a self-activating node of an adaptive network, the adaptive network including a plurality of nodes connected thereto, the self-activating node having a processor coupled to a memory containing computer-readable instructions which, when executed by the processor, cause the self-activating node to receive identifications of other nodes connected to the network; and, activate an administrative role on the self-activating node if the received identifications indicate that an active administrative role is desired.

The self-activating node may have computer-readable instructions causing the self-activating node to activate the administrative role on the self-activating node if the received identifications indicate that a number of nodes connected to the network exceed a predetermined number. The computer-readable instructions may cause the self-activating node to broadcast an administrative role activation notice to the others node connected to the network prior to activating the administrative role. The computer-readable instructions may cause the self-activating node to delay activation of the administrative role and monitor the network for conflict messages for a predetermined period of time after broadcasting the administrative role activation notice; and, cancel activation of the administrative role if any conflict messages are received. When the administrative role is active, the computer-readable instructions may cause the self-activating node to collect information regarding each other node of the plurality of nodes; determine network conditions from the collected information; compare the determined network conditions with one or more predetermined target conditions to identify any unfulfilled desired roles; and if an unfulfilled desired role is identified, send a role activation request to one of the other nodes connected to the network which is configured to fulfil that desired role. When the administrative role is active, the computer-readable instructions may cause the self-activating node to collect information regarding each other node of the plurality of nodes; determine network conditions from the collected information; compare the determined network conditions with one or more predetermined target conditions to identify any active undesired roles; and if an active undesired role is identified, send a role deactivation request to one of the other nodes connected to the network whereon the undesired role is active. When the administrative role is active, the computer-readable instructions may cause the self-activating node to compare the determined network conditions with one or more predetermined target conditions to identify any active undesired roles; and if an active undesired role is identified, send a role deactivation request to one of the other nodes connected to the network whereon that undesired role is active. When the administrative role is active, the computer-readable instructions may cause the self-activating node to collect information regarding each other node of the plurality of nodes by querying each of the other nodes connected to the adaptive network. When the administrative role is active, the computer-readable instructions may cause the self-activating node to collect information regarding each other node of the plurality of nodes by monitoring traffic on links of the adaptive network which are connected to the self-activating node.

Another aspect of the invention provides for a self-activating node of an adaptive network, the adaptive network including a plurality of nodes connected thereto, the self-activating node having a monitoring unit configured to receive identifications of other nodes connected to the network; and, an activation unit configured to activate an administrative role on the self-activating node if the received identifications indicate that an active administrative role is desired.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

In drawings which illustrate non-limiting embodiments of the invention:

FIG. 1 shows an embodiment of system for managing a network according to the invention;

FIG. 2 shows an embodiment of a node therein;

FIG. 3 shows an example of a method for managing a network according to the invention;

FIG. 4 shows an example of a method for operating a node according to the invention; and,

FIG. 5 shows another embodiment of a node according to the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Some embodiments of the invention described herein provide systems for managing computer networks. Some such systems may comprise a plurality of computer systems interconnected to one another by means of a communication system. Each computer system may comprise one or more “nodes”. The nodes of the computer systems may interact through the communication system to form an adaptive network. The network is configured to allow nodes to connect thereto and disconnect therefrom and to adapt the operation of connected nodes in response to network conditions.

Each node may be configured to fulfil one or more roles which may be selectively activated to perform functions for operating the network. The behaviour of each node is determined by the role(s) which is (are) active for that node. Example roles include:
(a) Centralized file storage (file server);
(b) Metadata storage (index server);
(c) Node/User authentication (security server);
(d) Policy enforcement;
(e) Permission validation for objects;
(f) Offline messaging server;
(g) Auditing server; and,
(h) Administrative (used for monitoring the network and activating roles as needed).

At least one node may be configured to perform an administrative role. A node in which an administrative role has been activated functions as an “administrative node.” An administrative node monitors network conditions and activates and deactivates the roles of nodes connected to the network. An administrative node may also be configured to perform other roles in addition to the administrative role, and may activate and deactivate such other roles in itself in response to network conditions and the amount of resources required to fulfil the administrative role.

An administrative node may activate and/or deactivate one or more roles of one or more nodes according to certain rules. A rule may specify certain “triggering conditions” which, when present in the network, call for the activation and/or deactivation of certain roles. Example triggering conditions include: load on the network, average response times, number of nodes connected to the network, etc. An administrative node may also activate and/or deactivate one or more roles of one or more nodes in response to input from a user such as a network administrator.

An administrative node has a list of rules for the network stored in a memory that is accessible to the administrative node. The rules may be specified by a network administrator. An administrative node may monitor network conditions and periodically check its rule list (e.g., by cycling through the items on the rule list) to identify rules which should be enforced.

A network may have multiple nodes configured to fulfil administrative roles. A network may have one or more rules which specify the number of administrative nodes desired for various network conditions. If the number of nodes with active administrative roles exceeds the number of desired administrative nodes, one or more of the administrative nodes may deactivate their administrative roles. If the number of nodes with active administrative roles is less than the number of desired administrative nodes, the administrative nodes may activate administrative roles in one or more nodes which are configured to fulfil administrative roles but in which the administrative roles are dormant.

If the administrative nodes of a network all share a database, all of the rules for the network may be stored in the database. When one administrative node begins enforcing a rule, that rule may be flagged in the database as “locked”, so that another administrative node does not attempt to enforce the same rule.

If the administrative nodes do not share a database, each administrative node may maintain a list of the rules it is enforcing, as well as all of the other rules for the network. When one administrative node begins enforcing a rule, that administrative node may send a message to the other administrative nodes indicating that that rule is being enforced. The other administrative nodes may then update their own rule lists to reflect the enforcement. The administrative nodes may periodically broadcast their rule lists to one another for synchronization. Each administrative node may periodically check its own rule list to identify rules which should be enforced and are not being enforced by another administrative node. Each administrative node may also be configured to delay for a predetermined period of time between each pass through its rule list, to ensure that the list is synchronized with the lists of other administrative nodes.

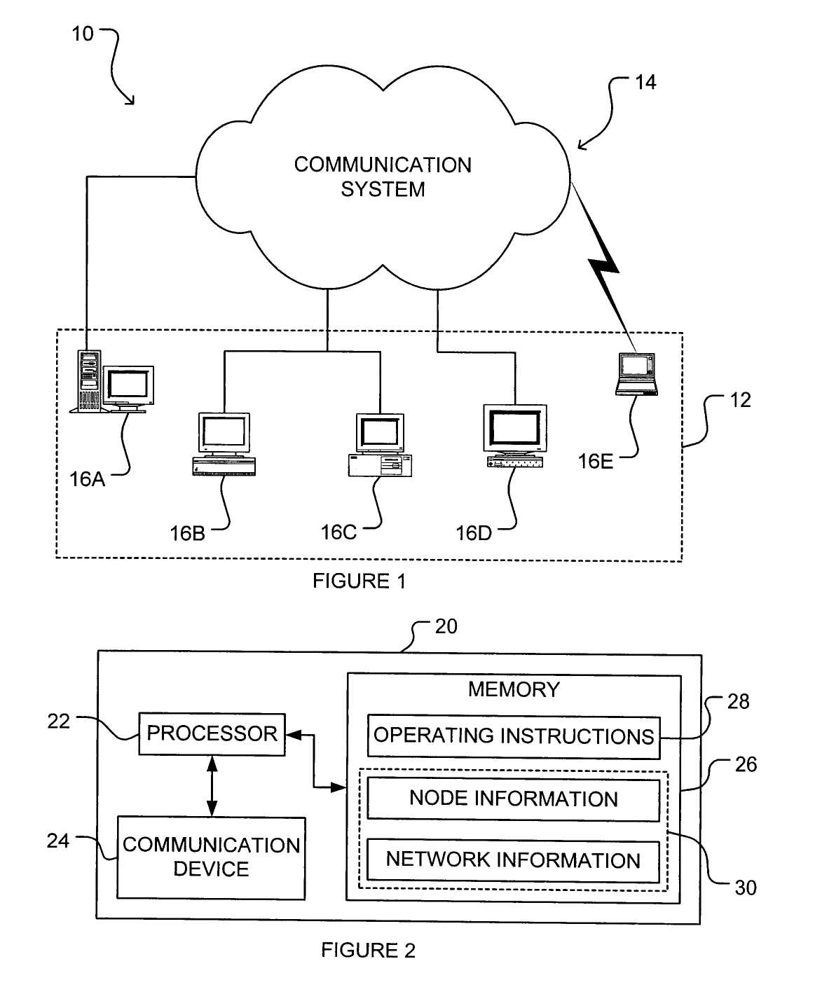

FIG. 1 shows a system 10 according to one embodiment of the invention. System 10 comprises a network 12 and a communication system 14. Network 12 comprises a plurality of computer systems 16 which may exchange messages with one another by means of communication system 14. Communication system 14 may comprise, for example, the Internet, a local area network, a wireless network, etc. Communication system 14 may comprise any mechanism that permits data communication among computer systems 16. In the illustrated embodiment, five computer systems 16A-E are shown, but it is to be understood that network 12 may comprise any number of computer systems 16.

Computer systems 16 may be of different types or of the same type, and may be connected to communication system 14 in any suitable manner. For example, in FIG. 1 computer systems 16A and 16D are each connected to communication system 14 by a physical connection, computer systems 16B and 16C share a physical connection to communication system 14, and computer system 16E is connected to communication system 14 by a wireless connection. Each computer system 16 may comprise one or more nodes.

FIG. 2 shows an example node 20 which may be located on one of computer systems 16. Node 20 comprises a processor 22 operably connected to a communication device 24 and memory 26. Memory 26 has operating instructions 28 and data 30 stored therein. Operating instructions 28 may comprise instructions specifying one or more roles which node 20 is configured to fulfil.

A single computer system 16 may comprise more than one node 20. Multiple nodes on a single computer system 16 may share processor 22 and communication device 24. Computer system 16 may also comprise additional memory allocated for storage of operating systems, computer programs and data files.

Data 30 may comprise, for example, node information 32 and network information 34. Node information 32 may comprise, for example, a node identity specifying roles which node 20 is configured to fulfil. Node information 32 may also comprise, for example, information about attributes of node 20. Network information 34 may comprise, for example, information about other nodes interconnected to node 20.

Node 20 has a basic or “default” operating state wherein node 20 performs basic operations relating to the operation of network 12. Such basic operations may include, for example, responding to requests for data stored in a location accessible to node 20. Node 20 may also comprise control means which permits node 20 to assume one or more roles in addition to its basic operations whereby node 20 performs functions for managing network 12. The control means may also cause node 20 to stop fulfilling roles in addition to its basic operations. Node 20 may assume a role by executing software which forms part of operating instructions 28 corresponding to that role.

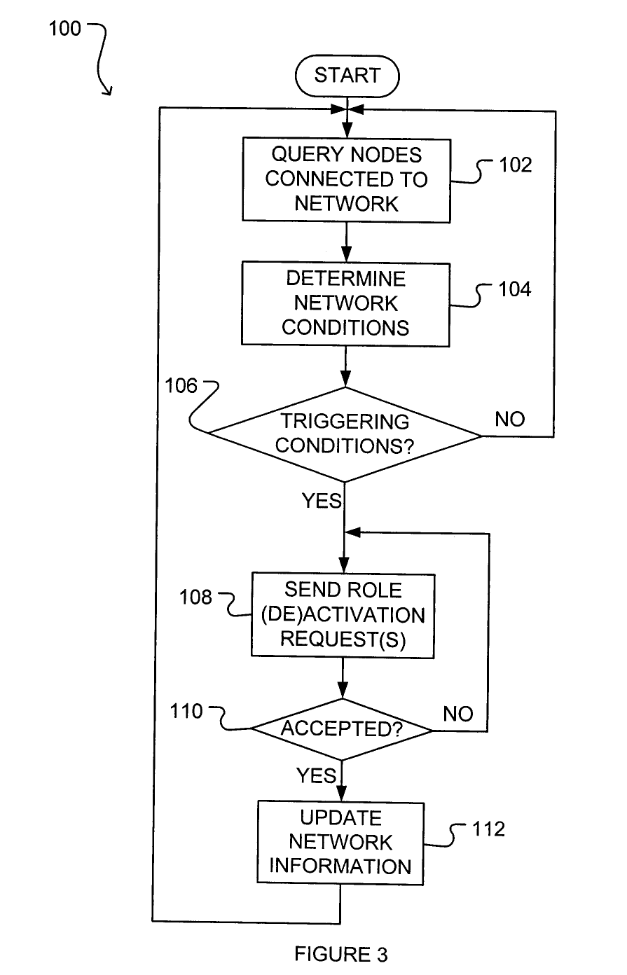

FIG. 3 shows an example method 100 for managing an adaptive network. Method 100 may be executed, for example, by a processor of a node according to operating instructions stored in memory. Method 100 may be carried out, for example, by a node which has an active administrative role for an adaptive network. In networks having more than one administrative node, the steps of method 100 may be carried out by any of the administrative nodes, either alone or in conjunction with one another. In the following paragraphs, the node which takes each step of method 100 is referred to herein as “the administrative node” to avoid confusion, but it is to be understood that each step need not be taken by the same administrative node.

At block 102, the administrative node queries the other nodes connected to the network. The administrative node may send out a query, for example, by broadcasting a message to all other nodes connected to the network identifying the administrative node and requesting information about the recipient nodes. Each node may reply by sending a message to the administrative node comprising information about active roles currently being fulfilled by the node, roles for which the node is configured but are not currently active, and performance of the node (e.g., uptime, latency, etc.)

At block 104, the administrative node determines the current network conditions. Network conditions determined by the administrative node may include one or more of:
(a) the number of nodes connected to the network;
(b) the number of nodes configured to fulfil each of a plurality of roles;
(c) the number of nodes on which each of a plurality of roles are active;
(d) the load on the network;
(e) node latency;
(f) node uptime;
(g) file/metadata synchronization state of each node;
(h) average number of message hops; and,
(i) highest number of message hops.
The administrative node may determine network conditions based on the responses to the queries of block 102. Additionally or alternatively, the administrative node may observe some network conditions directly, for example by monitoring traffic on links of the network which are connected to the administrative node.

At block 106 the administrative node determines whether any triggering conditions are present on the network. The presence of triggering conditions may be determined, for example, by comparing the current network conditions with one or more predetermined target conditions specified in a rule list stored in memory accessible to the administrative node. For example, the rule list may specify numbers and types of desired roles for each of a plurality of network conditions.

In some embodiments, the administrative node may compare the list of desired roles for the current network conditions with the actual number of nodes wherein the desired roles are active. For example, an administrative node may be enforcing a rule which specifies a threshold load, and calls for activation of a metadata index server role on one node when the current load of the network exceeds the threshold load. Similarly, a rule may call for activation of a file server role on one node if the number of nodes connected to the network exceeds a first predetermined number, and for deactivation of all file server roles if the number of nodes connected to the network is lower than a second, lower, predetermined number. In some networks, it may be desirable to enforce rules which call for the activation of a file server role and a metadata index server role when the number of nodes exceeds five hundred, for example.

If there are no triggering conditions present (block 106 NO output), method 100 returns to block 102. The administrative node cycles through the steps of blocks 102, 104 and 106 until triggering conditions are present in the network.

If triggering conditions are present (block 106 YES output), at block 108 the administrative node sends one or more role activation requests to one or more nodes that can be configured to fulfil the roles which are desired for the current network conditions on which such roles are not already active. The administrative node may also send one or more role deactivation requests to one or more nodes with active roles which are no longer desired for the current network conditions. The administrative node may direct role activation and deactivation requests to appropriate nodes based on the responses received to the queries of block 102.

The administrative node may also send one or more role activation requests to one or more nodes configured to fulfil roles which are specifically requested by a network administrator. This permits a network administrator to intervene in advance of expected events that may place unusual loads on the network, for example. The administrative node may be configured to only deactivate a role on such “manually” activated nodes once all automatically activated nodes performing that role have been deactivated. Likewise, the network administrator may specifically request that certain roles be deactivated on certain nodes, in which case the administrative node will not send role activation requests for such roles to such nodes.

At block 110, the administrative node determines whether the role (de)activation request(s) have been accepted. The administrative node may determine whether the role (de)activation request(s) have been accepted, for example, by waiting to receive a confirmation from the node(s) which have accepted the request(s). If the role (de)activation request(s) have not been accepted after a certain period of time (which may be predetermined or may be based on characteristics of the request(s)), (block 110 NO output), method 100 returns to block 108 and the administrative node may resend the request(s) or send the request(s) to one or more different nodes.

Once the role (de)activation request(s) have been accepted (block 110 YES output), the administrative node updates the network information at block 112. Method 100 then returns to block 102.

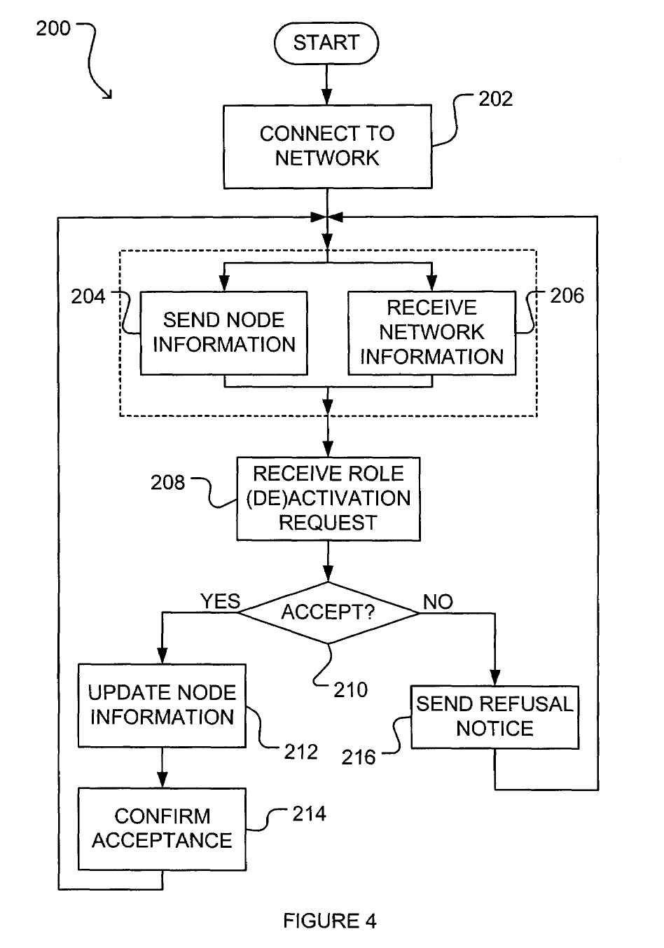

FIG. 4 shows an example method 200 for operating a node. Method 200 may be executed, for example, by a processor of a node according to operating instructions stored in memory. Method 200 may be carried out, for example by each of a plurality of nodes which make up an adaptive network.

At block 202, the node connects to a network. The node then sends node information out over the network at block 204 and receives network information at block 206. The order of the steps performed at blocks 204 and 206 is not important, as indicated by the dashed box around these blocks in FIG. 4. The node information sent at block 204 may be used by the administrative node(s) of the network to determine what type of role activation requests may be sent to that node. The network information received in block 206 may be updated any time information about other nodes connected to the network or information about the network itself is received.

Each node may continuously or periodically monitor network traffic for role activation requests. A request to activate or one of the roles for which the node is configured, or a request to deactivate one of the node's active roles, is received at block 208. At block 210 the node determines whether to accept the request. Conditions which could cause a node not to accept a role activation request include, for example, the load and/or available bandwidth of the node. A node will not refuse a role deactivation request, but may delay in accepting the request if the node is performing another action when the request is received.

If the node accepts the request (block 210 YES output), the requested role is (de)activated and the node information is updated at block 212. At block 214 the acceptance is confirmed by the node sending a confirmation to the administrative node from which the request originated, or to some other location specified in the request.

If the node does not accept a role activation request (block 210 NO output), a refusal notice is sent to the administrative node which sent the request at block 216. The administrative node may then forward the request to another node on the network which is configured for the desired role. The administrative node may determine which nodes are configured for desired roles based on network information received from the nodes.

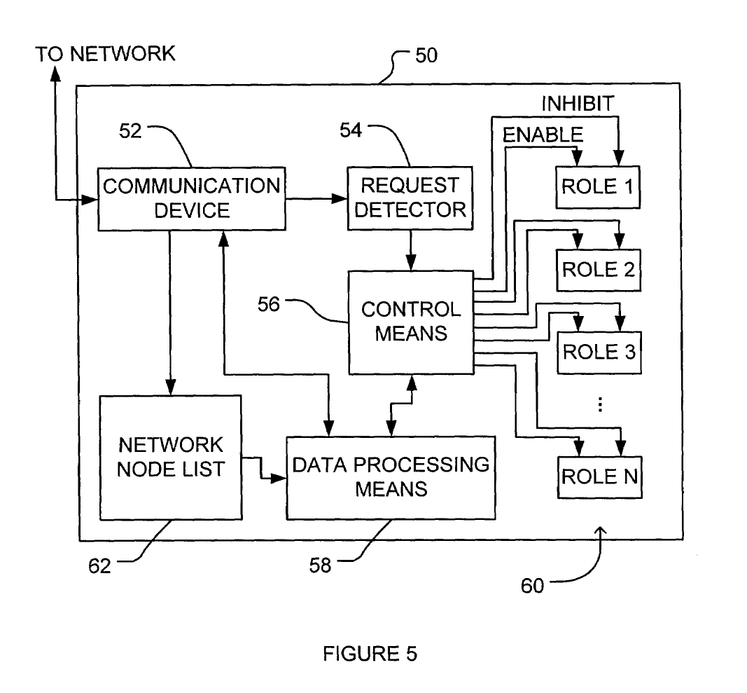

FIG. 5 shows an example node 50 according to another embodiment of the invention. Node 50 comprises a communication device 52 for exchanging messages with a network (not shown). A request detector 54 is connected to communication device 52 for monitoring the messages received from the network to identify any role activation or deactivation requests. Request detector 54 is coupled to control means 56, and passes on any role activation or deactivation requests to control means 56. Control means 56 determines whether to accept or refuse each request based on the status of node 50. For each request received, control means 56 causes data processing means 58 to send either an acceptance or a refusal message to the source of the request over the network by means of communication device 52. If the request is refused, control means 56 take no other action. If the request is accepted, control means 56 activates or deactivates one of roles 60 in accordance with the request, for example, by sending an enable or inhibit signal to the role identified in the request.

Data processing means 58 may be a processor, such as a CPU or the like, and may be working in conjunction with other data processing means. Control means may be software or firmware operable on node 50 in conjunction with data processing means 58, and may be implemented into node 50's operating system.

Communication device 52 may also receive information about other nodes connected to the network. Such information may comprise, for example, an identification of each node connected to the network and the active and dormant roles for each node. Such information may be stored in a network nodes list 62 accessible to data processing means 58.

One of roles 60 may comprise an administrative role. In some embodiments, data processing means 58 may optionally perform a network monitoring function as part of the basic operations of node 50. In such embodiments, data processing means 58 periodically or continuously monitors network nodes list 62, and causes control means 56 to activate the administrative role of node 50 if the information stored in network nodes list 62 indicates that the operation of the network may be facilitated by the activation of an administrative role. For example, data processing means 58 may cause control means 56 to activate the administrative role of node 50 if the number of nodes connected to the network exceeds a predetermined number. The network monitoring function may be disabled by a network administrator who does not want node 50 to activate its own administrative role.

In a network comprising a plurality of nodes such as node 50 which may activate their own administrative roles, conflicts between nodes may be minimized, for example, by data processing means 58 broadcasting an administrative role activation notice to the other nodes connected to the network prior to activating the administrative role. Data processing means 58 may then wait for a period of time and monitor communication device 52 for any conflict messages. If no conflict messages are received, data processing means 58 may then cause control means 56 to activate the administrative role for node 50.

As an example of operation of one embodiment of the invention, a network comprising a plurality of nodes initially operates as a pure peer-to-peer network, with each of the nodes performing their basic operations. An administrative role is activated on one of the nodes (either manually by a network administrator or automatically by the node itself), but there are no triggering conditions present in the network to cause the administrative node to activate any other roles. In such a configuration, a “searching” node wanting to obtain a file from the network must query each other node of the network.

As traffic and/or the number of nodes on the network increases, the administrative node detects the presence of triggering conditions specified by a rule which calls for an active file server role. The administrative node then sends a request to activate a file server role to a node configured to fulfil that role. The node which receives the request then activates the file server role, confirms acceptance of the request, and sends a message to the other nodes of the network indicating that it is performing a file server role. In this modified configuration, a searching node wanting to obtain a file from the network may do so by querying only the node with the active file server role.

Certain implementations of the invention comprise computer processors which execute software instructions which cause the processors to perform a method of the invention. For example, one or more processors in a computer system connected to a network may implement the methods described herein by executing software instructions in a program memory accessible to the processors. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links. The instructions may optionally be compressed and/or encoded.

Where a component (e.g. a computer, server, node, assembly, device, processor, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A system for managing a network, the system comprising:
a plurality of nodes connected to an adaptive network, each of the plurality of nodes comprising a processor coupled to a memory containing computer readable instructions which, when executed by the processor, cause the node to fulfill at least one role for operating the adaptive network, and instructions which, when executed by the processor, cause the processor to monitor for a request from an administrative node to activate said at least one role; and
wherein the administrative node has an active administrative role, and the administrative node is configured to determine network conditions and selectively send requests to activate roles on the plurality of nodes based on the network conditions.

2. A system according to claim 1 wherein the administrative node is configured to determine network conditions by querying other nodes connected to the adaptive network regarding network conditions observed by the other nodes.

3. A system according to claim 1 wherein the administrative node is configured to determine network conditions by monitoring traffic on links of the adaptive network which are connected to the administrative node.

4. A system according to claim 1 wherein the administrative node is configured to:
(a) compare the determined network conditions to one or more predetermined target conditions to identify any unfulfilled desired roles; and
(b) if an unfulfilled desired role is identified, send a role activation request to one of the plurality of nodes connected to the network which is configured to fulfill the desired role.

5. A system according to claim 1 wherein the administrative node is configured to:
(a) compare the determined network conditions to one or more predetermined target conditions to identify any active undesired roles; and
(b) if an active undesired role is identified, send a role deactivation request to one of the plurality of nodes connected to the network whereon the undesired role is active.

6. A system according to claim 4 wherein the administrative node is configured to:
(a) compare the determined network conditions to one or more predetermined target conditions to identify any active undesired roles; and
(b) if an active undesired role is identified, send a role deactivation request to one of the plurality of nodes connected to the network whereon the undesired role is active.

7. A system according to claim 1 wherein the administrative node is configured to:
(a) activate a metadata index server role on at least one of the plurality of nodes connected to the adaptive network if a load on the adaptive network exceeds a predetermined threshold load.

8. A system according to claim 1 wherein the administrative node is configured to:
(a) activate a file server role on at least one of the plurality of nodes connected to the adaptive network if a number of nodes connected to the adaptive network exceed a first predetermined number.

9. A system according to claim 8 wherein the administrative node is configured to:
(a) deactivate all file server roles on the plurality of nodes connected to the adaptive network if the number of nodes connected to the adaptive network is lower than a second predetermined number which is lower than the first predetermined number.

10. A system according to claim 1 wherein the administrative node is configured to:
(a) activate a metadata index server role and a file server role on one or more of the plurality of nodes connected to the adaptive network if a number of nodes connected to the adaptive network exceed 500.

11-12. (canceled)

13. A method for managing a network, the method comprising:
(a) providing a plurality of nodes connected to an adaptive network, each node comprising a processor coupled to a memory containing computer readable instructions which, when executed by the processor, cause the node to fulfill one or more roles for operating the adaptive network;
(b) querying the plurality of nodes to determine conditions of the adaptive network;
(c) determining one or more desired roles for the adaptive network based on the determined conditions;
(d) determining if any of the one or more desired roles are unfulfilled in the adaptive network; and
(e) for each unfulfilled desired role, sending a role activation request to one of the plurality of nodes configured to fulfill that desired role.

14. A method according to claim 13 comprising:
(a) determining one or more undesired roles for the adaptive network based on the determined conditions;
(b) determining if any of the one or more undesired roles are active in the adaptive network; and
(c) for each active undesired role, sending a role deactivation request to one of the plurality of nodes whereon the undesired role is active.

15. A method according to claim 13 wherein determining one or more desired roles comprises comparing the determined conditions to one or more predetermined target conditions.

16. A method according to claim 13 wherein determining one or more desired roles comprises designating a metadata index server role as a desired role if a load on the adaptive network exceeds a predetermined threshold load.

17. A method according to claim 13 wherein determining one or more desired roles comprises designating a file server role as a desired role if a number of nodes connected to the adaptive network exceeds a predetermined number.

18. (canceled)

19. A self-activating node of an adaptive network, the adaptive network comprising a plurality of nodes connected thereto, the self-activating node comprising a processor coupled to a memory containing computer-readable instructions which, when executed by the processor, cause the self-activating node to:
(a) receive identifications of other nodes connected to the network; and
(b) activate an administrative role on the self-activating node if the received identifications indicate that an active administrative role is desired.

20. A self-activating node according to claim 19 wherein the computer-readable instructions cause the self-activating node to:
(a) activate the administrative role on the self-activating node if the received identifications indicate that a number of nodes connected to the network exceed a predetermined number.

21. A self-activating node according to claim 19 wherein the computer-readable instructions cause the self-activating node to:
(a) broadcast an administrative role activation notice to the others node connected to the network prior to activating the administrative role.

22. A self-activating node according to claim 23 wherein the computer-readable instructions cause the self-activating node to:
(a) delay activation of the administrative role and monitor the network for conflict messages for a predetermined period of time after broadcasting the administrative role activation notice; and
(b) cancel activation of the administrative role if any conflict messages are received.

23. A self-activating node according to claim 19 wherein, when the administrative role is active, the computer-readable instructions cause the self-activating node to:
(a) collect information regarding each other node of the plurality of nodes; determine network conditions from the collected information; compare the determined network conditions with one or more predetermined target conditions to identify any unfulfilled desired roles; and if an unfulfilled desired role is identified, send a role activation request to one of the other nodes connected to the network which is configured to fulfill that desired role.

24-28. (canceled)
